(19) United States
(12) Patent Application Publication
(10) Pub. No.: US 2007/0271154 A1
(43) Pub. Date: Nov. 22, 2007

(54) Method for operating a catering business

(76) Inventors: Daniel Broudy, Pittsburgh, PA (US); Michael Broudy, Pittsburgh, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/431,052

(22) Filed: May 9, 2006

(51) Int. Cl. G06Q 30/00

(52) U.S. Cl. 705/27

(57) ABSTRACT

A comprehensive web based system which requires no software installation on behalf of the respective restaurant operators and which enables customers to place catering orders and scheduled pickup online. A website is established for the franchise owner which independently posts chain restaurant websites with unique catering information for each of the multi-location restaurants location restaurant websites by geographic location for menu review and online placement of catering orders to the selected restaurant. The multi-location restaurant operators are provided with respective online access to the respective chain restaurant websites for permitting them to receive catering orders and to independently modify their respective unique website catering information.

### FIELD OF THE INVENTION

The present invention relates to the operation of a catering business, and more particularly, to the operation of a catering business for a restaurant franchise having multi-location chain restaurants.

### BACKGROUND OF THE INVENTION

Currently multi-location chain restaurants engage in catering and takeout orders which are placed via telephone, fax or e-mail. This method of operation creates difficulties for customers who may encounter busy telephone lines or do not receive prompt responses to fax or e-mail.

It is a principal object of the present invention to address these deficiencies by creating a comprehensive web based application to enhance the ability of multi-location chain restaurants to manage catering orders, while maintaining unique menus, terms and conditions, and order transmission policies for each unique site.

### SUMMARY OF THE INVENTION

The present invention provides an electronic commerce system and method for providing customers with the ability to locate a unique location from among all available sites of a multi-location chain restaurant and to select items from its unique catering or takeout menu. The orders can be placed online for future pickup and delivery and the system allows payment options, processing of credit card information via secure pathways and transmission of the completed orders via fax, telephone or e-mail directly from the website.

Through the use of unique software the present invention provides a method of operating a catering business for a restaurant franchise having multi-location chain restaurants. The method comprises establishing a website for the franchise owner which independently posts chain restaurant websites with unique catering information for each of the multi-location restaurants respectively. Online access is provided to the website by customers for selection of one of the multi-location restaurant websites by location for menu review and online placement of catering orders to the selected restaurant. Respective online access is further provided to the independent chain restaurant websites by the respective chain restaurant operators for thereby permitting them to receive catering orders to also and independently modify their respective unique website catering information.

The method of the present invention also permits customer order placement to be accomplished with online shopping cart technology, and also permits the customer to schedule order pickup and delivery and make payment arrangements. The unique website catering information provided on the respective websites includes such information as menu, location, terms and conditions and method of notification information.

Tiered access levels are provided to the restaurant websites for activity reporting to enable operators to track and evaluate their catering business. The franchise owner is provided with access to all levels of the website for tracking and evaluating the catering business of all multi-location restaurants.

As an added advantage, the website may also be provided with capabilities which permits the respective chain restaurant operators to store and analyze data from sales not originating from the website.

The unique system of the present invention allows each of the multi-location restaurant sites to have a unique menu, unique posting of information pertaining to store hours, terms and conditions of pickup and delivery and payment, location maps and directions. Each location of the multi-location chain restaurants is allowed to create specials, promote discounts, and alter the menu on a regular basis on the website. Customers can use advanced shopping cart technology in assembling and placing orders and customers can store their order history online to facilitate reorders and provide automatic e-mail confirmation.

Accordingly, a significant advantage is provided to the chain restaurant operators with a system that is entirely web based with no software to be installed by the respective restaurant operators. Orders can be received via facsimile, e-mail, or telephone notification, and point of sale system integration is available. The system also includes management reporting features which permits operators to tract sales by customer, item, date, specific location, group of locations, or the entire franchise group.

Tiered access levels are also made available for reporting features. Specifically, individuals at various management levels can view sales data based on their level of authorization. For example, a store manage can view data for his own store. A regional manager can view data for stores in his region and an franchise owner can view data from all stores. In addition, operators can utilize the website to store and analyze data from sales not originating on the website.

### BRIEF DESCRIPTION OF THE DRAWING

Other objects and advantages appear hereinafter in the following description and claims. The accompanying drawing shows, for the purpose of exemplification, without limiting the scope of the invention or the appended claims, certain features of the present invention.

FIG. 1 is a block flow diagram illustrating the method of operating a catering business in accordance with the teachings of the present invention.

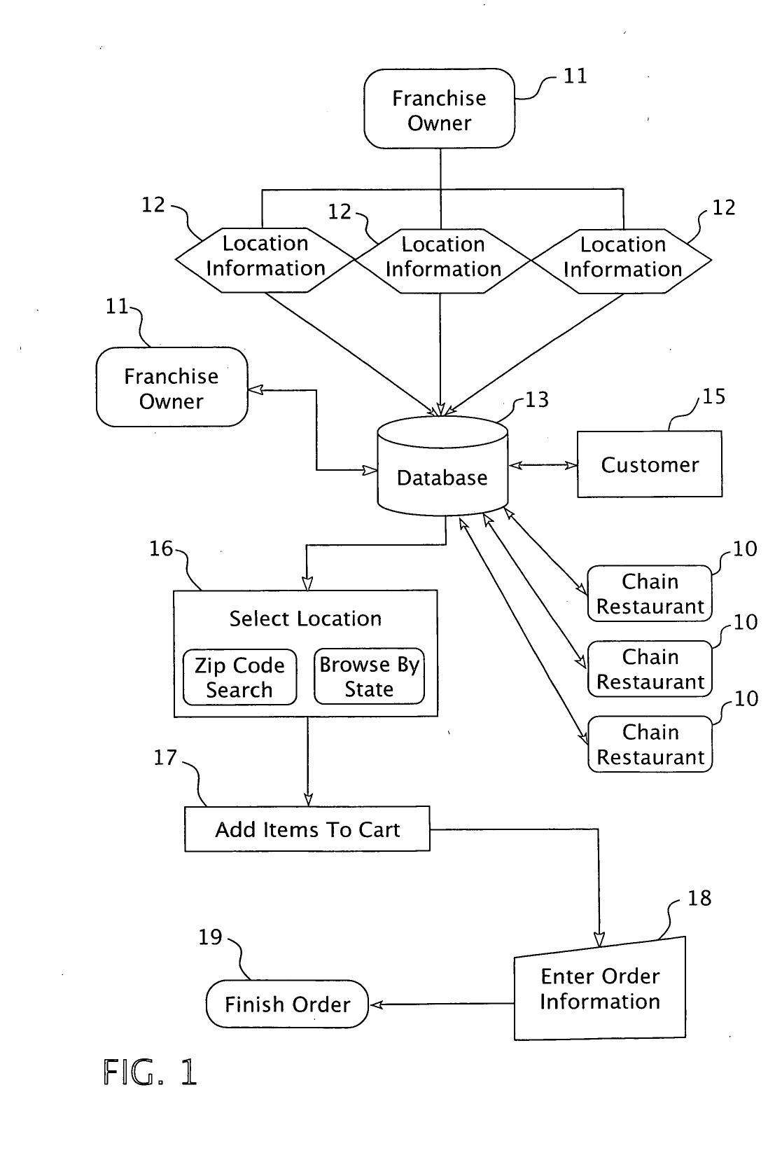

### DETAILED DESCRIPTION OF THE INVENTION

Referring to the drawing, the method of the present invention is illustrated by the flow chart for operating a catering business for a restaurant franchise, including the franchise owner 11, and multi-location chain restaurants having different location information 12. Unique software permits the franchise owner information and location information 12 of each chain restaurant to be fed into the data base 13 of the central processing unit. Franchise owner corporate information for all franchises is also injected into the data base 13 of the CPU as indicated at 14. Through use of sequel database software a website database is thus generated for the franchise owner which independently posts chain restaurant websites with unique catering information for each of the multi-location restaurants respectively.

The customer 15 is provided with online access to the website for selection of one of the multi-location restaurant websites as indicated at 16 by location and then for menu review and placement of catering orders, preferably by shopping cart techniques, to the selected restaurant as indicated at steps 17, 18 and 19.

It is indicated by the double ended arrows in the diagram, that respective online access is provided to the independent chain restaurant websites by the respective chain restaurants for thereby permitting them to receive catering orders and independently modify the respective unique website catering information. This unique website catering information may include menu, location, terms and conditions and method of notification type information.

In entering order information at step 18, the customer 15 order placement also includes the scheduling of order pickup and delivery and payment arrangements.

As also indicated by the double ended arrows in the flowchart, tiered access levels are provided to the restaurant websites for activity reporting to enable operators of chain restaurants 10 to track and evaluate their catering business. The franchise owner 11 is provided with access to all levels of the website 3 for tracking and evaluating the catering business of all the multi-location restaurants 10.

As an added advantage, the base website may also be provided with capabilities which permits the respective chain restaurant operators to store and analyze data from sales not originating on the website.

The online catering system of the present invention is web based whereby the chain restaurant operators are not required to install any software. The system of the present invention provides online ordering, scheduling of pickup or delivery and eliminates telephone calls, increases order accuracy and creates customer loyalty. The system further enables customers to find the most convenient restaurant of the chain.

The system of the present invention also permits the respective multi-chain restaurants to customize menus per location and to promote specials online and to utilize reporting features to track customers.

The entire and existing restaurant point of sale information is totally integrated and permits and provides reporting to all levels of operation.

I claim:

1. A method of operating a catering business for a restaurant franchise having multi-location chain restaurants, comprising:
establishing a website for the franchise owner which independently posts chain restaurant websites with unique catering information for each of the multi-location restaurants respectively;
providing online access to said website by customers for selection of one of said multi-location restaurant websites by location for menu review and online placement of catering orders to said selected restaurant, and
providing respective online access to said independent chain restaurant websites by the respective chain restaurants for thereby permitting them to receive catering orders and independently modify their respective unique website catering information.

2. The method of claim 1, wherein said customer order placement is accomplished with online shopping cart technology.

3. The method of claim 2, wherein said customer order placement also includes the steps of scheduling order pickup and delivery and making payment arrangements.

4. The method of claim 1, wherein said unique website catering information includes menu, location, terms and conditions and method of notification information.

5. The method of claim 1, including providing tiered access levels to said restaurant websites for activity reporting to enable operators to track and evaluate their catering business.

6. The method of claim 5, wherein the franchise owner is provided with access to all levels of the website for tracking and evaluating the catering business of the multi-location restaurants.

7. The method of claim 6, including providing capabilities on said website which permits the respective chain restaurant operators to store and analyze data from sales not originating on the website.
